(19) United States
(12) Patent Application Publication
(10) Pub. No.: US 2015/0106928 A1
(43) Pub. Date: Apr. 16, 2015

(54) SCREENING OF EMAIL TEMPLATES IN CAMPAIGN MANAGEMENT

(71) Applicants: JOERG STEINMANN, Volklingen (DE); Dirk Wagner, Marpingen (DE); Christoph Birkenhauer, Wiesloch (DE); Martin Steiert, Heidelberg (DE)

(72) Inventors: JOERG STEINMANN, Volklingen (DE); Dirk Wagner, Marpingen (DE); Christoph Birkenhauer, Wiesloch (DE); Martin Steiert, Heidelberg (DE)

(21) Appl. No.: 14/053,603

(22) Filed: Oct. 15, 2013

(51) Int. Cl. H04L 12/58; H04L 29/06

(52) U.S. Cl. CPC H04L 51/30; H04L 63/145
USPC 726/23; 709/206

(57) ABSTRACT

Various embodiments of systems and methods for uploading email templates in campaign management are described herein. In an aspect, the method includes screening an email template prior to uploading the email template to a campaign management application. The criteria for screening includes, but is not limited to, scanning for malware, checking for conformance with code page, and checking for conformance of placeholders with pre-defined format or syntax. Upon detecting an error an error message is notified to a user otherwise the email template is uploaded to the campaign management application for executing an email campaign.

### BACKGROUND

Some enterprises market their products, services, and offers to customers through various modes of campaigning such as email campaign, letter campaign, phone campaign, etc. In an email campaign, enterprises send a marketing email to a large number of recipients. In many instances, the marketing email is created using an email template and personalized for individual recipients. For example, certain dynamic portions of the email template called place holders are replaced with attributes personal to the recipient. Usually, the email templates are defined outside a campaign management application and required to be uploaded into the campaign management application for defining email campaigns for generating emails. Often, the emails generated using the email templates are error prone. For example, the emails may be subject to malware and errors relating to format, syntax, etc. Executing a campaign using an error prone email template means sending out several hundreds of erroneous emails to recipients. Once sent out, it is practically impossible to rectify the erroneous emails received at the recipient end.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an overview of an exemplary environment for uploading email template from an external device to a campaign management application, according to an embodiment.

FIG. 2 illustrates a user interface for defining an email campaign in the campaign management application, according to one embodiment.

FIG. 3 illustrates an exemplary graphical user interface showing an error message related to the email template, according to an embodiment.

FIG. 4 illustrates an exemplary graphical user interface showing an error message related to the email template, according to another embodiment.

FIG. 5 illustrates an exemplary graphical user interface showing an error message related to the email template, according to yet another embodiment.

FIG. 6 illustrates an exemplary graphical user interface showing an error message related to the email template, according to yet another embodiment.

FIG. 7 illustrates an exemplary graphical user interface showing an error message related to the email template, according to another embodiment.

FIG. 8 is a flow chart of a process for uploading an email template to a campaign management application, according to an embodiment.

FIG. 9 is a block diagram of an exemplary computer system, according to an embodiment.

### DESCRIPTION

Embodiments of techniques for screening of email templates in campaign management are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Software as a service (SaaS) sometimes referred to as “on-demand software” is a software delivery model in which software and associated data are centrally hosted on the cloud. SaaS is typically accessed by users using a thin client via a web browser. SaaS has become a common delivery model for many business applications, including accounting, collaboration, customer relationship management (CRM), management information systems (MIS), enterprise resource planning (ERP), etc. SaaS applications are hosted centrally where software and data are stored on host servers. The applications can be run on a PC with an internet connection and a web browser. One such SaaS offering is SAP® Business ByDesign from SAP® AG.

The SAP® Business ByDesign solution offers several modules designed to track end-to-end business processes. For example, Customer relationship management (CRM) is one such module designed to support processes that span marketing, sales and service activities. Marketing includes a variety of activities such as creating and running marketing campaigns across multiple channels, connecting with target customers, generating leads, etc. One of the marketing functions supported by SAP® CRM module is campaign management to control the complete marketing campaign processes including design, execution, coordination, optimization, and monitoring.

Enterprises use campaigns such as email campaign, short message service (SMS) campaign, letter campaign, phone campaign, etc., for marketing products, services, and offers to customers and/or business partners. Enterprises have hundreds or thousands of business partners and customers. Marketing campaigns such as email campaign requires email to be sent in huge volume referred to as bulk email. Bulk email is dissemination of large number of emails to people across the globe. Typically, in such marketing campaigns, bulk emails are processed in batches referred to as batch processing. Batch processing is execution of series of programs or jobs on a processing unit without manual intervention.

As used herein, an email campaign refers to a campaign for marketing products, services, and offers through emails. Email campaigns are defined in a campaign management application. The campaign management application controls the complete marketing campaign processes including design, execution, coordination, optimization, and monitoring. The campaign management application includes user interfaces for gathering various inputs related to the email campaign such as a ‘name’ of the campaign, ‘start date’ of the campaign, and ‘end date’ of the campaign, etc. In addition to these inputs, an email template is also uploaded to the campaign management application for defining the email campaign. Release FP4.0 of SAP® Business ByDesign solution provides for the use of email templates for generating an email.

An “email template” as used herein is a mail body which includes a predefined text and one or more place holders. The predefined text within the email template is specific to the campaign. In an embodiment, the predefined text comprises hypertext markup language (HTML). The place holders within the email template hold the place for receiving a variable or any attribute personal to the recipient. For example, a place holder may represent a personal attribute such as recipient's name (e.g., ‘RecipientName’), Recipient Title or designation (e.g., ‘Title’), academic title, etc., to be used in the email campaign. In an aspect, the email template may be created using any third party HTML editor such as Microsoft® expression web, Adobe® Dreamweaver, etc.

In an aspect, the email templates are created at an external source (3^{rd} party) using state-of-the-art tools as a file. The email templates may be stored as files (e.g., text files) comprising HTML texts. The stored email templates or files are uploaded into the CRM system. The externally created email template is then uploaded into the campaign management application and may be stored in a local file.

The stored email template may be selected and uploaded from the external device to the campaign management application where the email campaign is to be created. At the time of creating a new email campaign, an email template is selected from the local file based upon the campaign to be defined. For example, a customer relationship management (CRM) manager may select one of a CRM marketing email template to define an email campaign related to CRM marketing. Once the email template is selected and uploaded to the campaign management application and other inputs related to the email campaign is provided by a user (e.g., CRM manager), the email campaign is defined and saved. The saved email campaign may be executed based upon the provided input.

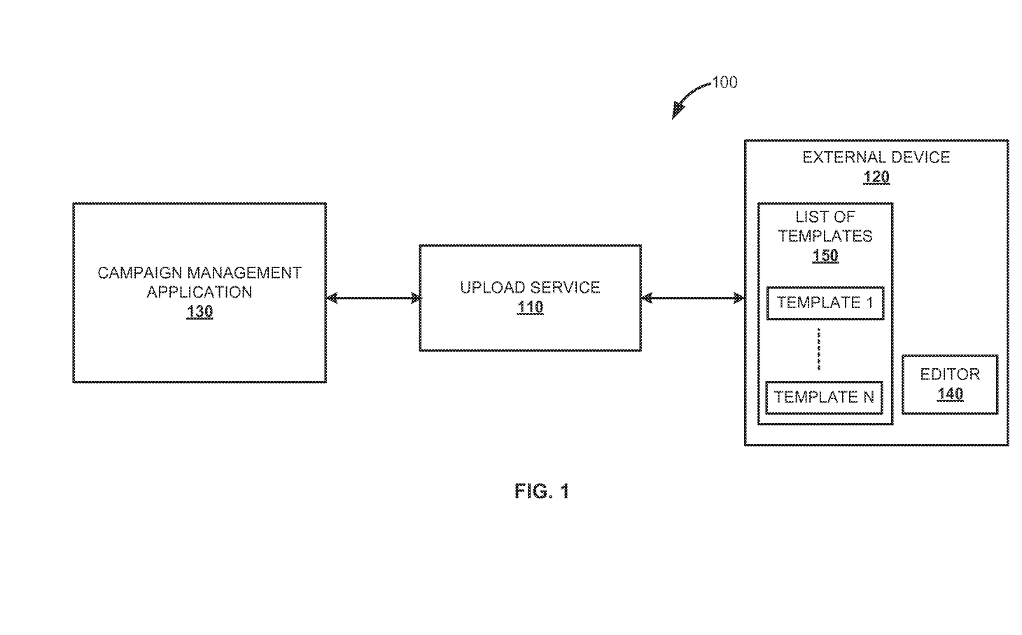

During execution, various issues related to the emails might be detected such as emails including viruses or emails including errors related to format, syntax, or content etc. However, as the email campaigns are executed automatically without user intervention, executing the campaign using the error prone email template would result in the generation and distribution of several thousands of erroneous emails to customers. It is therefore prudent to screen the email template for potential errors prior to executing the campaign and sending out the emails to the customers. One or more embodiments described herein provide for screening the email templates for errors automatically without user intervention. The following example embodiments illustrated with reference to FIG. 1 to FIG. 9, describe in detail the email template uploading service for successful execution of email campaign.

FIG. 1 is a block diagram illustrating an overview of an exemplary environment 100 including an upload service 110 for uploading email templates (e.g., template 1 to template N) from an external device 120 to a campaign management application 130. The campaign management application 130 is communicatively coupled to the upload service 110 which in turn is communicatively coupled to the external device 120. The external device 120 may be any 3^{rd} party device positioned outside the campaign management application 130. In an embodiment, the external device 120 includes an editor 140 for creating email templates. The created email templates (e.g., template 1 to template N) are stored in the external device 120. In an embodiment, the email templates (e.g., template 1 to template N) are stored in a list of templates 150. Typically, upon receiving a selection of an email template from the stored email templates, the email template is uploaded into the campaign management application 130.

However, according to some embodiments of this disclosure, upon receiving a selection of an email template for uploading, the upload service 110 screens the email template for any errors prior to loading the selected template into the campaign management application 130. In an aspect, the upload service 110 is a part of the campaign management application 130. In an embodiment, the criteria for screening include, but are not limited to, scanning for malware, checking for conformance of placeholders with pre-defined format or syntax, and content check. Upon screening, if any error is detected, the error is notified or reported to a user. For example, an error message may be rendered on a user interface. The user may then rectify the notified error and upload the email template again into the campaign management application 130. In an embodiment, when the screening is performed successfully and no error is detected, the selected email template is uploaded to the campaign management application 130.

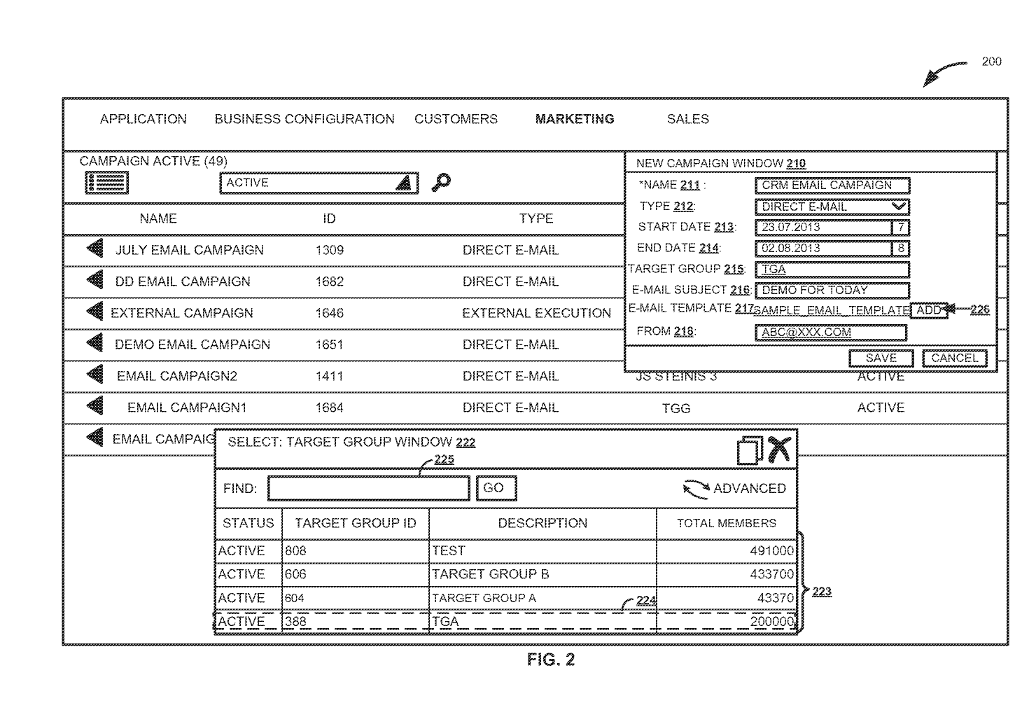

In an embodiment, a new campaign is created by defining certain parameters such as the campaigning period, the target group of recipients, templates for email creation, etc. As shown with reference to FIG. 2, the campaign creation process is initiated by selecting an option “New Campaign” from the user interface 200. In response to receiving the selection to create a new campaign, the campaign management application 130 opens a modal window (e.g., a new campaign window 210) on the user interface 200. The new campaign window 210 provides fields for receiving inputs for creating the new campaign. In the given example, the new campaign window 210 includes fields for receiving inputs defining a ‘name’ 211 of the campaign, a ‘type’ 212 of the campaign, a ‘start date’ 213 for the campaign, an ‘end date’ 214 of the campaign, a ‘target group’ 215 of recipients, an ‘email subject’ 216 for the campaign, an ‘email template’ 217 and a ‘from’ 218 indicating email address of a sender. In the given example, the input received for the field ‘name’ 211 is “CRM email campaign”. The input received for the field ‘type’ 212 is “direct e-mail.” Herein, ‘Type’ 212 refers to the type of email campaign such as ‘direct email’, ‘letter’, ‘SMS’ etc. The input received for the field ‘Start date’ 213 is “23.07.2013” and for field ‘end date’ 214 is “02.08.2013.” ‘Start date’ 213 and ‘end date’ 214 specify the start date and the end date of the email campaign, respectively. The input received for the field ‘target group’ 215 is “TGA”, the input received for the field ‘email subject’ 216 is ‘DEMO FOR TODAY’, and the input received for the field ‘from’ 218 is “abc@xxx.com.” ‘From’ 218 specifies a from email address from which the email is dispatched to the recipients.

The ‘target group’ 215 as used herein refers to a classification of recipients grouped on the basis of certain shared marketing attributes such as age, occupation, hobbies, income, gender, etc. The term “recipients” as used herein refers to either an account such as an organization, a contact person for an organization, or an individual having an email address, fax or phone number. Within the campaign management application, the target groups are assigned to a marketing activity, such that, when the activity is executed, the recipient list associated with the target group is forwarded to the campaign application for further processing.

In an aspect, upon receiving a selection of the field “target group” 215, a widow 222 showing a list 223 of stored target groups is rendered on the user interface 200. For example, selecting the target group “TGA” with 200000 members to its group and which is currently in an “active” state adds the target group “TGA” to the newly created campaign “CRM email campaign” in the new campaign window 210. The “active” state indicates that the target group is currently operative and can be selected. Specific target groups can also be searched using “find” 225 option provided in the graphical user interface 200 of the campaign management application 130.

The created email templates are stored in the external device 120. e.g., in the ‘list of templates’ 150. In an embodiment, the email templates are stored as files in the list 150. The email template for creating the email for the email campaigns may be imported from the external device 120 to a local file. A particular email template may then be uploaded from the local file to the new campaign by selecting an “Add” option 226 in the new campaign window 210. Selecting the “Add” option 226 opens a file selector pop-up showing a list of email templates. Upon receiving a selection of a particular email template and prior to uploading, an API of the campaign management application is called which performs a screening of the selected email template. In an embodiment, the API may be the upload service 110 which performs the screening of the selected email template. In an embodiment, the email template is screened for errors including but not limited to scanning for malware, checking for conformance with code page, checking for conformance of placeholders with pre-defined format or syntax, and content check.

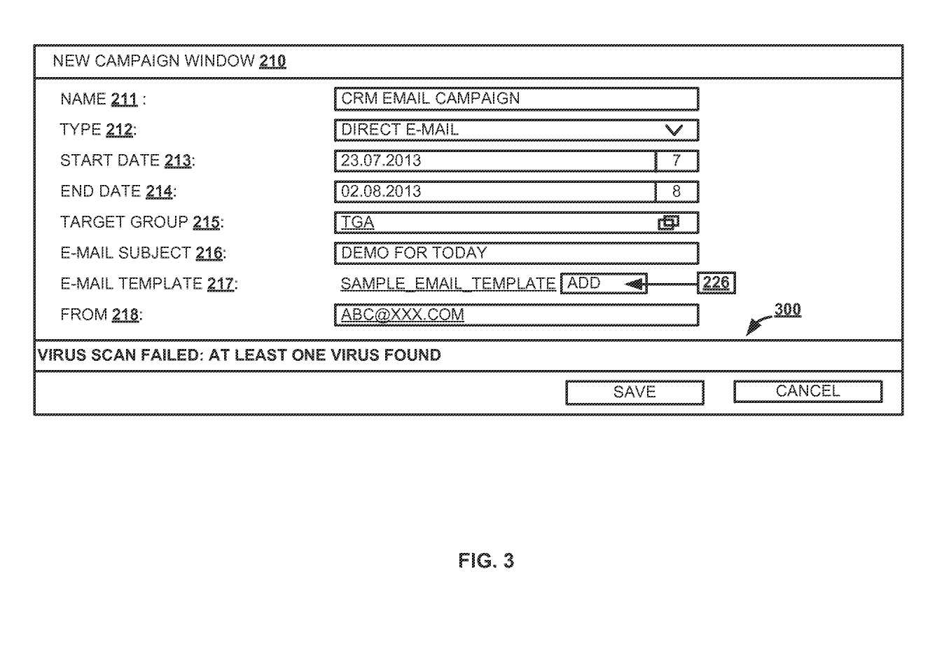

In an embodiment, prior to uploading the email template, the upload service 110 screens the email template for malware such as presence of one or more viruses. A state-of-art virus scan process may be adopted for determining the presence of virus. In an embodiment, virus check software is called to check the presence of virus within the email template. In an embodiment, a service of SAP® NetWeaver with a special virus checking profile for marketing campaigns is called for performing virus scan. Typically, behind the SAP® NetWeaver service a 3^{rd} party virus check software may be called to check the presence of viruses within the email template. When one or more viruses are detected within the email template, an error message may be rendered or notified. FIG. 3 shows an exemplary error message 300 rendered when the one or more viruses are detected within the email template. In case of virus related error, the virus removing software may be called to remove the virus from the email template. When the virus is removed, the email template may be uploaded again.

In an embodiment, the screening includes checking for conformance with code page. In an embodiment, once the virus check is performed successfully and no virus is detected, the code page check is performed. Typically, each character in the email template is stored as a sequence of ‘bits and bytes’ and a code page defines or encodes which ‘bits and bytes’ corresponds to which character. There are various types of code pages, e.g., universal character set transformation format 8 (UTF-8), Windows 1252, etc. The code page contains characters for various languages such as western European languages, eastern European languages, Cyrillic language, Hindi language, etc. In an embodiment, the code page UTF-8 is used for webpages and HTML. Therefore, a predefined code page for the email template may be specified as “UTF-8.” For checking conformance with code page, the upload service 110 determines whether the email template content is encoded according to the predefined code page.

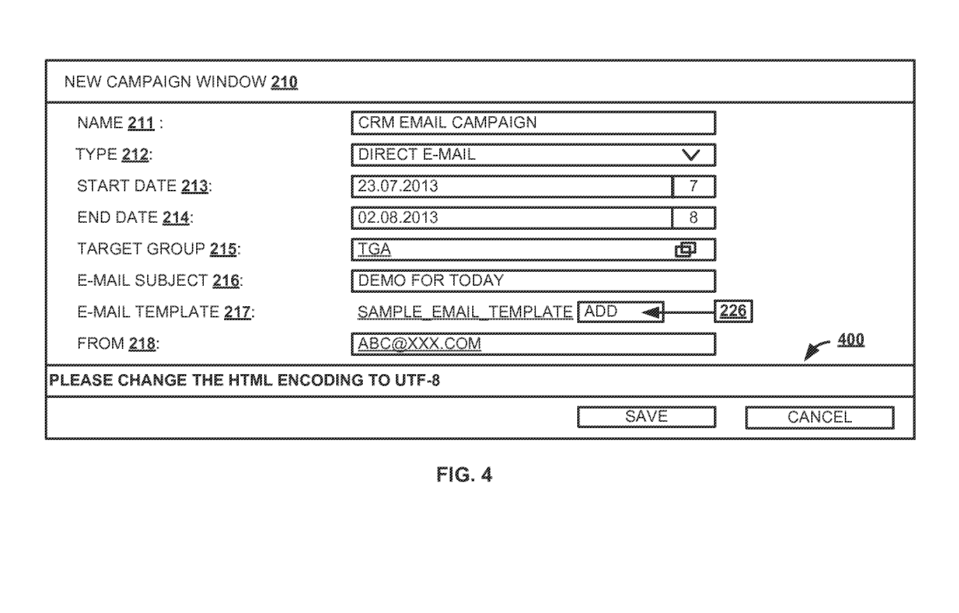

Typically, the beginning of the email template file includes a specific byte order mark “BOM” to indicate the code page in which the email template content is encoded. For example, for UTF-8, the BOM is “EE BB BF.” The upload service 110 determines whether the file includes a BOM at the beginning of the email template file. If it is determined that the file includes the BOM, the upload service 110 proceed to determine whether the BOM is in accordance with a pre-specified BOM, e.g., “EE BB BF.” If the upload service determines that the BOM is not in accordance with the pre-specified BOM, a code page error may be rendered or notified. FIG. 4 shows an exemplary error message 400 rendered when the file includes BOM other than the pre-specified BOM. When the error related to code page is rendered, the HTML encoding of the email template content is changed by the user to UTF-8 and the email template may be uploaded again. When BOM is in accordance with the pre-specified BOM, it is determined that the email template content is encoded according to the predefined code page UTF-8.

On the other hand, if it is determined that the file does not include the BOM, the upload service 110 determines whether the selected email template includes a predefined HTML tag with a specified value. In an aspect, the upload service 110 searches for the predefined tag, e.g., tag <meta> within the HTML tags of the email template. When the predefined HTML tag is detected, the upload service 110 checks the value or content of the tag, i.e., content of tag <meta>. For code page UTF-8, the content of tag <meta> is “<meta content=“text/html; charset=UTF-8”>”. ‘Charset’ represents character set. The upload service 110 checks whether the ‘charset’ within the tag <meta> is equals to UTF-8. When the ‘charset’=UTF-8, it is determined that the email template content is encoded according to the predefined code page UTF-8. In case the ‘charset’≠UTF-8, it is determined that the email template content is not encoded according to the predefined code page UTF-8 and the error message 400 is rendered. When the code page error is rendered, the HTML encoding of the email template is changed by the user to UTF-8 and the email template is uploaded again.

Upon determining that the email template conforms to the pre-defined code page, the data stream of the email template is converted from the markup language (HTML) to an extensible markup language such as Extensible HyperText markup language (XHTML). During conversion, it is determined whether the email template includes any formatting error or error related to at least one of a format, syntax, and content of the email template. For example, it is determined whether the email template includes any tag not in accordance with the markup language syntax (e.g., HTML syntax). In an embodiment, a tag indicates or marks a start and an end of an element (e.g., a logical unit of information) within a document or a programming language. In an embodiment, the tag begin with the less-than character (“<”) and end with the greater-than character (“>”). The HTML tag indicates the start and the end of the logical unit of information within the hypertext markup language. In an embodiment, the HTML email template includes HTML tags and it is determined whether the email template includes any non HTML. In an embodiment, the tags not in accordance with the HTML syntax are called unknown tags or non-HTML tags.

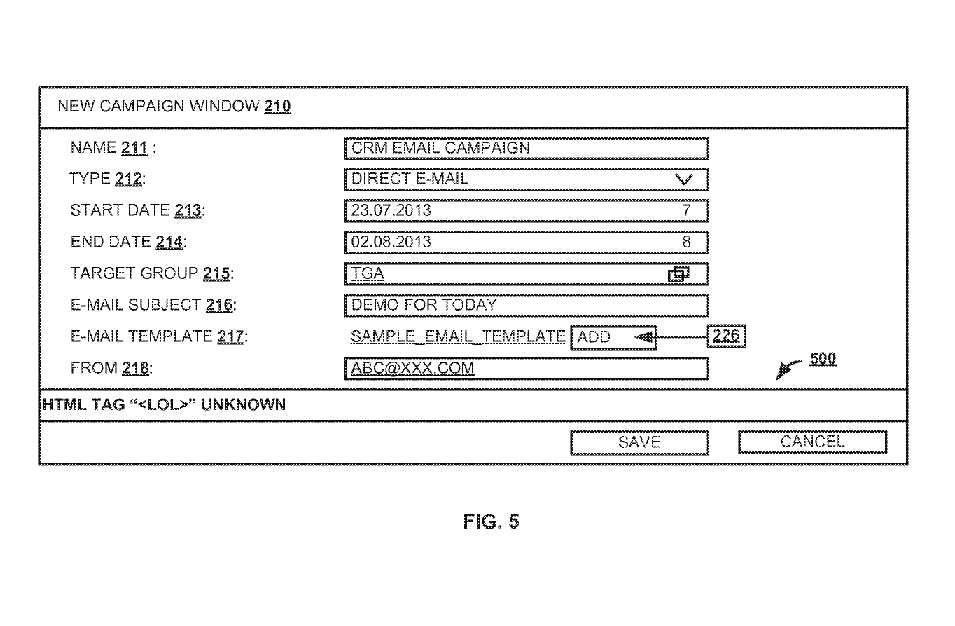

When the email template includes any unknown tag, an error is rendered or notified to the user. In an embodiment, the upload service 110 parses the email template file content and searches for HTML tags. When any tag of the email file content is unknown (i.e., non HTML tag), the error is rendered. FIG. 5 displays an exemplary error 500 rendered on detecting an unknown tag. In case there is no formatting error and the file is in HTML format, the file is converted to the XHTML format.

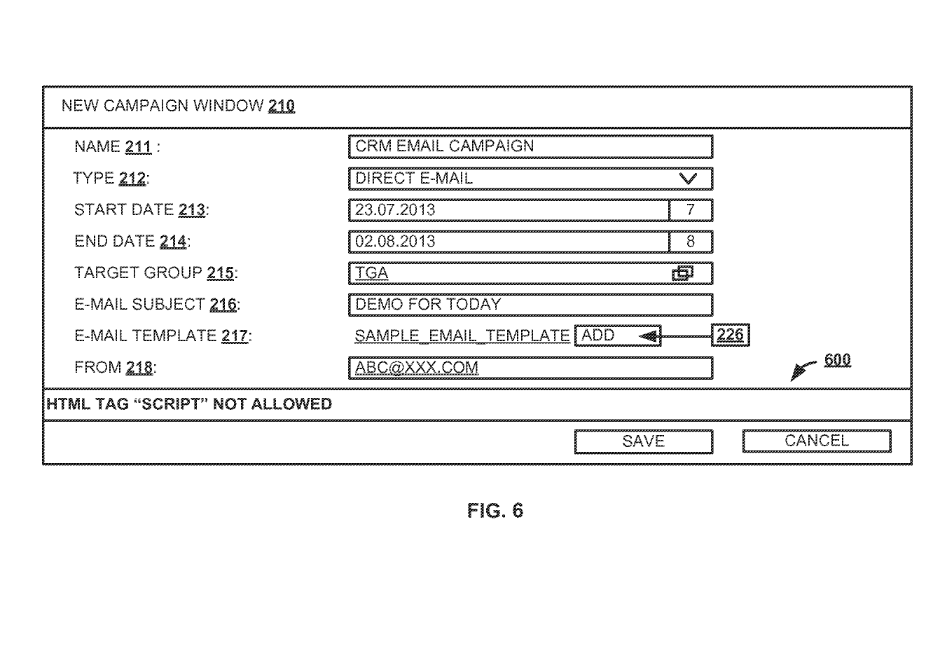

In an embodiment, during conversion, it is determined whether the file contains any restricted tags or scripts. In an embodiment, the restricted tag comprises a link element (e.g., hyperlink) which points to a multimedia file. In an embodiment, the multimedia file includes at least one of an audio, a video, and text. In an embodiment, the restricted tag may be tag new with HTML 5, e.g., <audio>, <video>, <object>. In one embodiment, the restricted tag may be <script> tag. When the file includes the restricted tag or script, an error is displayed. FIG. 6 shows an exemplary error message 600 rendered when a restricted “script” is detected. In case there is no restricted tag error, the file is converted to the extensible markup language, e.g., XHTML. In an embodiment, the restricted tag error may be performed after conversion and prior to uploading the email template to the campaign management application 130.

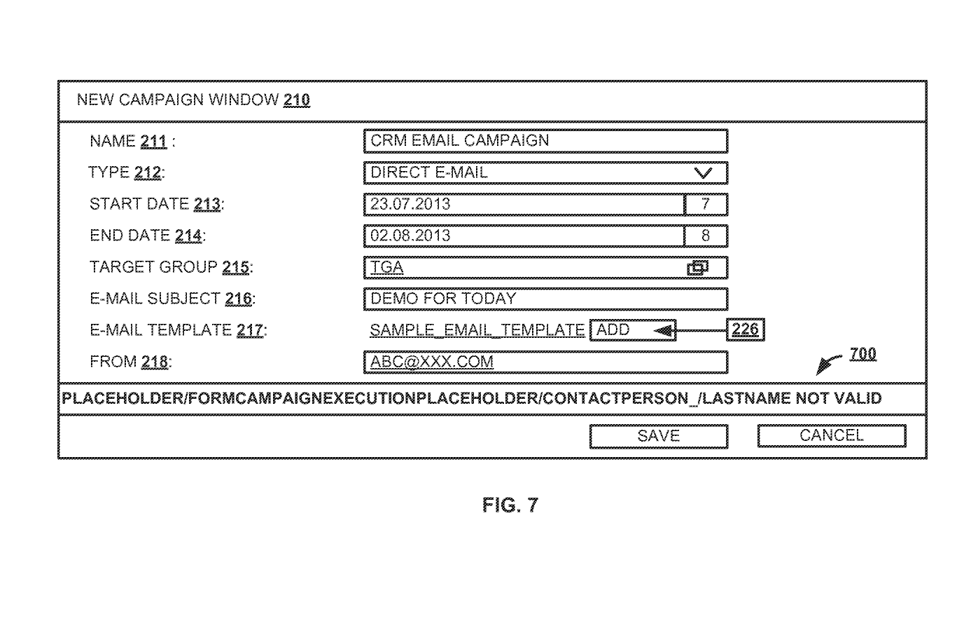

Upon conversion to XHTML, the document object model (DOM) tree representation of the email template (HTML) is created. In an aspect, XHTML is parsed into an extensible markup language (XML) DOM tree representation. Using DOM tree representation of the HTML, the HTML tags containing the placeholders can be easily, quickly, and correctly accessed or searched. The searched placeholder can then be easily checked, e.g., whether the placeholders comply with the predefined syntax. In an embodiment, the searched placeholders are compared with the list of predefined placeholders. When a placeholder does not comply with predefined placeholder syntax, an error message is rendered. FIG. 7 shows an exemplary error message 700 rendered when wrong placeholder is detected.

In an embodiment, the comments for rectifying errors are also rendered along with the respective errors. Once the errors are rectified, the selected email template can be uploaded again. Until the execution of the campaign the selected email template can be changed by just uploading a different template. In an aspect, in case the uploaded template contains errors (e.g. virus or invalid HTML code or wrong code page or wrong placeholder names) the template is rejected and corresponding error messages are rendered on the user interface.

In an embodiment, the content of the uploaded HTML file will be stored as XHTML in a node MAIL_FORM (not shown) of BO Campaign. In an aspect, the user manually enters the subject line for the uploaded email template. When the email template is uploaded, the description of the email template is displayed as hyperlink. Selecting this hyperlink opens a browser window and allows for preview of the email template. Once the error free email template is uploaded, other inputs related to the email campaign are provided to create the email campaign. The created email campaign “CRM email campaign” can be ‘saved’ or ‘saved and opened’ for viewing in the graphical user interface 200 of the campaign management application 130. The user schedules to execute the created email campaign and to send email to recipients. In campaign management application 130, the target group of recipients is grouped into packages. These packages are executed in parallel in batches of defined batch size to send personalized email to the recipients in the target group.

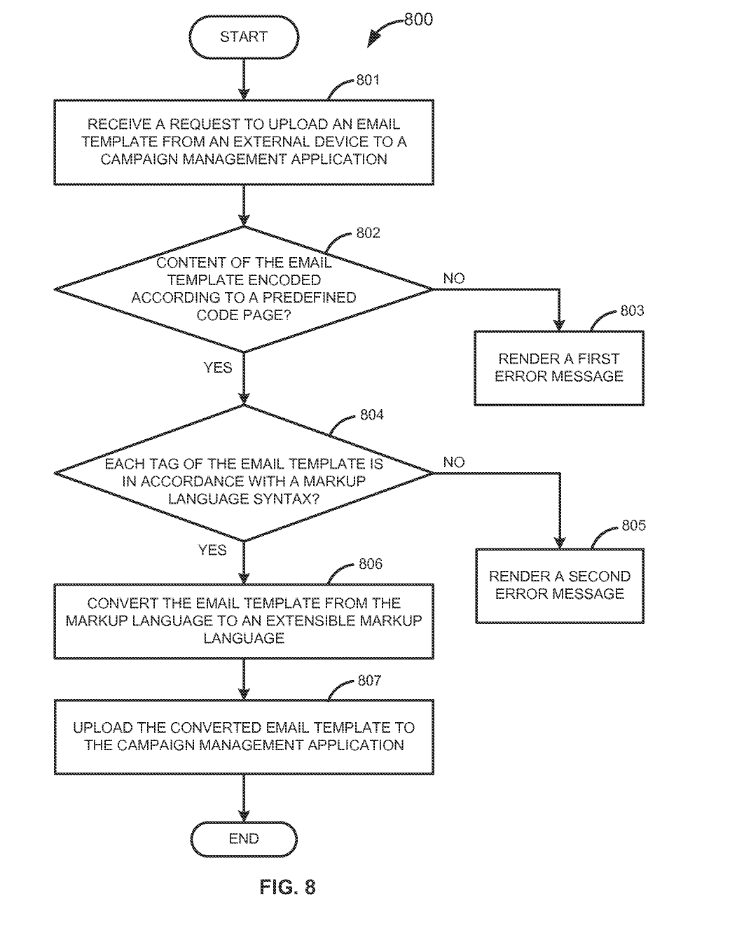

FIG. 8 is a flowchart illustrating process 800 to upload email template to a campaign management application (e.g., campaign management application 130 of FIG. 1). A request for uploading the email template from an external device (e.g., external device 120 of FIG. 1) to the campaign management application is received at 801. The external device may be a 3^{rd} party device external to the campaign management application. Once the request is received, an upload service (e.g., upload service 110 of FIG. 1) screens the email template for any errors prior to loading the email template into the campaign management application 130. In an embodiment, the criteria for screening include, but are not limited to, scanning for malware, checking for conformance of placeholders with pre-defined format or syntax, and content check. For example, the upload service scans whether the email template includes malware (e.g., viruses). In an embodiment, the presence of malware is detected using state-of-art malware detecting software such as virus detecting software. When the malware (e.g., virus content) is detected, an error message (e.g., error message 300 of FIG. 3) related to virus content may be rendered. In an embodiment, screening includes conformance with code page. In an embodiment, the check for conformance of code page is performed after malware detection. For code page check, the upload service determines whether the email template content is encoded according to a predefined code page at 802. In an embodiment, the predefined code page may be UTF-8. For determining whether the email template is encoded in the predefined code page, the upload service determines whether the email template file includes the pre-specified BOM. For example, the upload service 110 determines whether the email template file includes the BOM “EE BB BF.” When the pre-specified BOM is included, it is determined that the email template content is encoded according to the predefined code page. In an embodiment, when the BOM is not the pre-specified BOM, it is determined that the email template content is not encoded according to the predefined code page. In an embodiment, when the file does not include the BOM, the upload service determines whether the email template includes a code page tag with a pre-specified value. When the email template includes the code page tag with the pre-specified value, it is determined that the email template content is encoded according to the predefined code page. In an embodiment, the code page tag is <meta> and the pre-specified value for tag <meta> is <meta content=text/html; charset=UTF-8>. In an embodiment, when the email template does not include the code page tag with the pre-specified value then it is determined that the email template content is not encoded according to the predefined code page.

When the email template content is not encoded according to the predefined code page (802: NO), an error message (e.g., error message 400 of FIG. 4) related to code page is rendered at 803. When the email template content is encoded according to the predefined code page (802: YES), the upload service determines whether the email template is in a specified markup language format (e.g., HTML format) and includes valid tags (e.g., HTML tags). In an aspect, it is determined whether each tag of the email template is in accordance with the markup language syntax (HTML syntax) at 804. When each tag of the email template is not in accordance with the markup language syntax (804: NO), an error message related to the tag is rendered at 805. In an embodiment, the tag not in accordance with the markup language syntax is considered as unknown tag. When each tag of the email template is in accordance with the markup language syntax (804: YES), the email template is converted from the markup language to an extensible markup language (e.g., XHTML) at 806. The converted email template is uploaded from the external device to the campaign management application at 807.

In an embodiment, after conversion, the upload service determines whether the placeholders within the email template comply with the predefined syntax. When any of the placeholders does not comply with the predefined syntax, an error message is rendered. In an embodiment, the placeholder syntax check may be performed during conversion. In an embodiment, after conversion, the upload service determines whether the email template includes any restricted tag. In an embodiment, the restricted tag comprises a link element (e.g., hyperlink) which points to a multimedia file. In an embodiment, the multimedia file includes at least one of an audio, a video, and text. In an embodiment, the restricted tag may be tag new with HTML 5. e.g., <audio>, <video>, <object>. In one embodiment, the restricted tag may be <script> tag. When the email template includes any restricted tag, an error message is rendered. In an embodiment, the restricted tag check may be performed during conversion.

Embodiments enable using state-of-art HTML editors to create email templates for marketing campaigns. Valid placeholders can be easily selected and inserted within the email templates. The created email template is stored on a server or on an external 3^{rd} party device where it is created. One of the stored email templates can be selected and uploaded to a campaign management application for defining the email campaign. Typically, the email template is assigned to an application business object, e.g., marketing campaign. The email template is screened prior to uploading it into the campaign management application. The criteria for screening includes, but is not limited to, scanning for malware, checking for conformance with code page, and checking for conformance of placeholders with pre-defined format or syntax. In an aspect, the screening is performed automatically and upon determination of any error, the error is reported to the user. Therefore, the erroneous email templates are not uploaded and the errors can be rectified at upload time itself. Further, there are no issues later during execution of the marketing campaign which helps in batch processing where marketing campaigns are executed automatically without human intervention.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

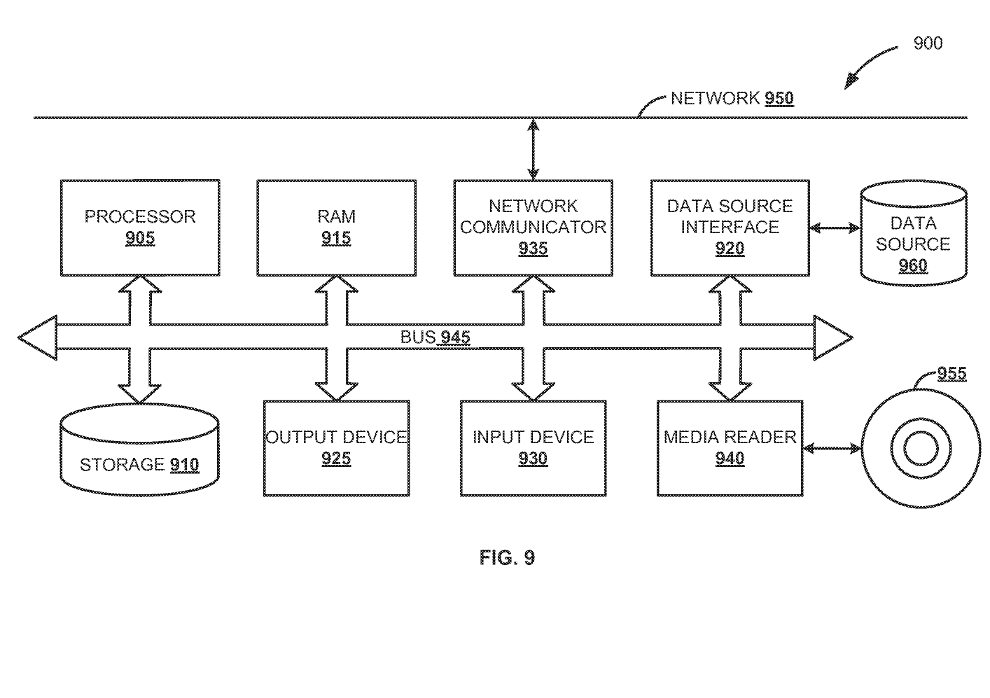

FIG. 9 is a block diagram of an exemplary computer system 900. The computer system 900 includes a processor 905 that executes software instructions or code stored on a computer readable storage medium 955 to perform the above-illustrated methods. The processor 905 can include a plurality of cores. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. According to some embodiments, such as some in-memory computing system embodiments, the RAM 915 can have sufficient storage capacity to store much of the data required for processing in the RAM 915 instead of in the storage 910. In some embodiments, all of the data required for processing may be stored in the RAM 915. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. An article of manufacture including a non-transitory computer readable storage medium to tangibly store instructions, which when executed cause a computer to:
receive a request to upload an email template from an external device to a campaign management application, wherein the email template is in a markup language having one or more tags;
prior to uploading, screen the email template for errors comprising:
determining whether a content of the email template is encoded according to a predefined code page;
upon determining that the content of the email template is not encoded according to the predefined code page, rendering a first error message;
upon determining that the content of the email template is encoded according to the predefined code page, determining whether the one or more tags are in accordance with the markup language syntax; and
upon determining that at least one of the one or more tags is not in accordance with the markup language syntax, rendering a second error message;
convert the email template from the markup language to an extensible markup language upon determining that each of the one or more tags are in accordance with the markup language syntax; and
upload the converted email template to the campaign management application.

2. The article of manufacture of claim 1, wherein the external device is a third party device external to the campaign management application.

3. The article of manufacture of claim 1, wherein the one or more tags indicate a start and an end of a logical unit of information within the email template.

4. The article of manufacture of claim 1, wherein the markup language is a hypertext markup language (HTML) and the extensible markup language is an extensible hypertext markup language (XHTML).

5. The article of manufacture of claim 1, wherein determining whether the content of the email template is encoded according to the predefined code page comprises:
determining whether a byte order mark is included in beginning of a file comprising the email template;
upon determining that the byte order mark is included:
determine whether the byte order mark is a pre-specified byte order mark;
upon determining that the byte order mark is the pre-specified byte order mark, notify that the content of the email template is encoded according to the predefined code page; and
upon determining that the byte order mark is not the pre-specified byte order mark, notify that the content of the email template is not encoded according to the predefined code page;
upon determining that the byte order mark is not included in beginning of the file, determine whether the email template includes a code page tag having a pre-specified value;
upon determining that the email template does not include the code page tag having the pre-specified value, notify that the content of the email template is not encoded according to the predefined code page; and
upon determining that the email template includes the code page tag having the pre-specified value, notify that the content of the email template is encoded according to the predefined code page.

6. The article of manufacture of claim 1 further comprising instructions, which when executed cause the computer to:
prior to uploading, screening the email template for malware; and
upon determining that the email template has malware, rendering an error message related to malware.

7. The article of manufacture of claim 1 further comprising instructions, which when executed cause the computer to:
upon converting the email template from the markup language to the extensible markup language, determine whether one or more placeholders within the email template comply with a predefined syntax, wherein the one or more placeholders are for receiving variables personal to a recipient;
upon determining that the one or more placeholders do not comply with the predefined syntax, render an error message related to non-compliance of the one or more placeholders; and
upon determining that each of the one or more placeholders comply with the predefined syntax, upload the email template from the external device to the campaign management application.

8. The article of manufacture of claim 1 further comprising instructions, which when executed cause the computer to:
prior to uploading, determine whether the one or more tags comprises a link element that points to a multimedia file; and
upon determining that the email template includes the one or more tags comprising the link element, display an error message.

9. The article of manufacture of claim 8, wherein the multimedia file includes at least one of an audio and a video.

10. A computer-implemented method for email campaign comprising:
receiving a request to upload an email template from an external device to a campaign management application, wherein the email template is in a markup language having one or more tags;
prior to uploading, screening the email template for errors comprising:
determining whether a content of the email template is encoded according to a predefined code page;
upon determining that the content of the email template is not encoded according to the predefined code page, rendering a first error message;
upon determining that the content of the email template is encoded according to the predefined code page, determining whether the one or more tags are in accordance with the markup language syntax; and
upon determining that at least one of the one or more tags is not in accordance with the markup language syntax, rendering a second error message; converting the email template from the markup language to an extensible markup language upon determining that each of the one or more tags are in accordance with the markup language syntax; and
uploading the converted email template to the campaign management application.

11. The method of claim 10, wherein determining whether the content of the email template is encoded according to the predefined code page comprises:
determining whether a byte order mark is included in beginning of a file comprising the email template;
upon determining that the byte order mark is included:
determine whether the byte order mark is a pre-specified byte order mark;
upon determining that the byte order mark is the pre-specified byte order mark, notify that the content of the email template is encoded according to the predefined code page; and
upon determining that the byte order mark is not the pre-specified byte order mark, notify that the content of the email template is not encoded according to the predefined code page;
upon determining that the byte order mark is not included in beginning of the file, determine whether the email template includes a code page tag having a pre-specified value;
upon determining that the email template does not include the code page tag having the pre-specified value, notify that the content of the email template is not encoded according to the predefined code page; and
upon determining that the email template includes the code page tag having the pre-specified value, notify that the content of the email template is encoded according to the predefined code page.

12. The method of claim 10 further comprising:
prior to uploading, screening the email template for malware; and
upon determining that the email template has malware, rendering an error message related to malware.

13. The method of claim 10 further comprising:
upon converting the email template from the markup language to the extensible markup language, determine whether one or more placeholders within the email template comply with a predefined syntax, wherein the one or more placeholders are for receiving variables personal to a recipient;
upon determining that the one or more placeholders do not comply with the predefined syntax, render an error message related to non-compliance of the one or more placeholders; and
upon determining that each of the one or more placeholders comply with the predefined syntax, upload the email template from the external device to the campaign management application.

14. The method of claim 10 further comprising:
prior to uploading, determine whether the one or more tags comprises a link element that points to a multimedia file; and
upon determining that the email template includes the one or more tags comprising the link element, display an error message.

15. A computer system for email campaign comprising:
at least one memory to store program code; and
at least one processor communicatively coupled to the at least one memory, the at least one processor configured to execute the program code to:
receive a request to upload an email template from an external device to a campaign management application, wherein the email template is in a markup language having one or more tags;
prior to uploading, screen the email template for errors comprising:
determining whether a content of the email template is encoded according to a predefined code page;
upon determining that the content of the email template is not encoded according to the predefined code page, rendering a first error message;
upon determining that the content of the email template is encoded according to the predefined code page, determining whether the one or more tags are in accordance with the markup language syntax; and
upon determining that at least one of the one or more tags is not in accordance with the markup language syntax, rendering a second error message;
convert the email template from the markup language to an extensible markup language upon determining that each of the one or more tags are in accordance with the markup language syntax; and
upload the converted email template to the campaign management application.

16. The computer system of claim 15, wherein the at least one processor is configured to determine whether the content of the email template is encoded according to the predefined code page by:
determining whether a byte order mark is included in beginning of a file comprising the email template;
upon determining that the byte order mark is included:
determine whether the byte order mark is a pre-specified byte order mark;
upon determining that the byte order mark is the pre-specified byte order mark, notify that the content of the email template is encoded according to the predefined code page; and
upon determining that the byte order mark is not the pre-specified byte order mark, notify that the content of the email template is not encoded according to the predefined code page;
upon determining that the byte order mark is not included in beginning of the file, determine whether the email template includes a code page tag having a pre-specified value;
upon determining that the email template does not include the code page tag having the pre-specified value, notify that the content of the email template is not encoded according to the predefined code page; and
upon determining that the email template includes the code page tag having the pre-specified value, notify that the content of the email template is encoded according to the predefined code page.

17. The computer system of claim 15, wherein the at least one processor is further configured to:
prior to uploading, screening the email template for malware; and
upon determining that the email template has malware, rendering an error message related to malware.

18. The computer system of claim 15, wherein the at least one processor is further configured to:
upon converting the email template from the markup language to the extensible markup language, determine whether one or more placeholders within the email template comply with a predefined syntax, wherein the one or more placeholders are for receiving variables personal to a recipient;
upon determining that the one or more placeholders do not comply with the predefined syntax, render an error message related to non-compliance of the one or more placeholders; and
upon determining that each of the one or more placeholders comply with the predefined syntax, upload the email template from the external device to the campaign management application.

19. The computer system of claim 15, wherein the at least one processor is further configured to:
prior to uploading, determine whether the one or more tags comprises a link element that points to a multimedia file; and
upon determining that the email template includes the one or more tags comprising the link element, display an error message.

20. The computer system of claim 19, wherein the multimedia file includes at least one of an audio and a video.
